(19) United States
(12) Patent Application Publication
(10) Pub. No.: US 2001/0043661 A1
(43) Pub. Date: Nov. 22, 2001

(54) Method and system for reducing plasma loss in a magnetic mirror fusion reactor

(76) Inventor: William J. Emrich JR., Huntsville, AL (US)

Correspondence Address: James J. McGroary, NASA/Marshall Space Flight Center, LS01/Office of Chief Counsel, Marshall Space Flight Center, AL, 35812, US

(21) Appl. No.: 09/726,859

(22) Filed: Nov. 30, 2000

Related U.S. Application Data
(63) Continuation-in-part of application No. 09/334,411, filed on Jun. 16, 1999, now abandoned.

(51) Int. Cl. G21B 1/00; G21J 1/00

(52) U.S. Cl. 376/140

(57) ABSTRACT

A method and system are provided for reducing plasma loss from the main chamber of a magnetic mirror fusion reactor (MMFR). The MMFR includes a mirror magnet defining a throat region and main chamber magnets defining a main chamber region adjacent the throat region. The present invention generates a field reversed configuration (FRC) inside the MMFR and only between the mirror magnet and the main chamber magnet that is adjacent to the mirror magnet.

This is a continuation-in-part of co-pending application Ser. No. 09/334,411 filed Jun. 16, 1999.

### ORIGIN OF THE INVENTION

The invention was made by an employee of the United States Government and may be manufactured and used by or for the Government for governmental purposes without the payment of any royalties.

### BACKGROUND OF THE INVENTION

1. Field of the Invention

This invention relates to magnetic mirror fusion reactors. More specifically, the invention is a method and system for reducing plasma loss in a magnetic mirror fusion reactor by plugging the throat of the reactor.

2. Description of the Related Art

One type of fusion reactor known in the art is a magnetic mirror fusion reactor (MMFR). As illustrated in FIG. 1, an MMFR 10 includes a main chamber region 11 defined by a plurality of main chamber magnets 12. Either end of MMFR 10, only one of which is illustrated in FIG. 1, has a throat region 13 defined by a mirror magnet 14. Magnetic field lines 16 generated in main chamber region 11 are constricted at throat region 13 by stronger magnetic field generated by mirror magnet 14. Note that main chamber magnets 12 and mirror magnet 14 are ring-shaped, but are shown cut away to clearly illustrate magnetic field lines 16. Main chamber region 11 is an evacuated region filled with fusing plasma 20. To create the necessary vacuum on earth, an evacuated vessel 22 is needed to hold fusing plasma 20. Note that vessel 22 may not be required in a space application.

Although the MMFR is considered promising as a main line fusion device, a problem that needs to be addressed is the loss of fusing plasma 20 through throat region 13. In current MMFR designs, fusing plasma 20 escapes through throat region 13 at unacceptable rates. Efforts to reduce the rate of fusing plasma loss have largely centered on ways to reduce the effective cross-sectional area of throat region 13 by, for example, increasing the field strength of mirror magnet 14 or using multiple mirrors in throat region 13. However, increasing the field strength of mirror magnet 14 either increases stress on the existing magnet or requires the use of a larger and more expensive magnet, while the complexity and ineffectiveness of multiple mirrors makes their use unacceptable. Thus, none of these efforts have been able to reduce plasma losses and yield a practical reactor design.

Other methods for combatting the problem of plasma loss at the throat region involve the use of plasma reflecting mechanisms positioned just outside the throat region(s). That is, as the plasma tries to escape the main chamber region through the throat region(s), the plasma reflecting mechanisms reflect escaping plasma back into the main chamber region. Such approaches are disclosed in U.S. Pat. Nos. 3,655,508 and 4,430,290.

Still another method of reducing plasma loss from a main chamber region is disclosed in U.S. Pat. No. 3,668,068 where strong electromagnetic waves are injected into the regions near the throats of a mirror device. These waves have a frequency slightly above the ion cyclotron frequency to prevent the ions from absorbing the injected electromagnetic waves. The electromagnetic waves essentially “push” the ions back into the device's main chamber much in the way pressure waves would act on a fluid medium.

Yet another method of reducing plasma loss from a main chamber region is disclosed in U.S. Pat. No. 4,314,879 (the '879 patent) where a field reversed configuration is generated in the entirety of the main chamber. However, a field reversed configuration large enough to occupy a reactor's entire main chamber is likely to be unstable thereby reducing its effectiveness.

Another device based on the concept disclosed in the afore-mentioned '879 patent is disclosed in U.S. Pat. No. 4,166,760 where several devices like the one described in the '879 patent are linked together in an end-to-end fashion. The resulting system is complex as it replaces one large main plasma chamber with a series of mirror cells, each of which must limit plasma loss therefrom.

### SUMMARY OF THE INVENTION

Accordingly, it is an object of the present invention to provide a method and system for reducing plasma loss in a magnetic mirror fusion reactor.

Another object of the present invention is to provide a simple and economical method and system for reducing plasma loss in a magnetic mirror fusion reactor.

A still further object of the present invention is to provide a stable method and system for reducing plasma loss in a magnetic mirror fusion reactor.

Other objects and advantages of the present invention will become more obvious hereinafter in the specification and drawings.

In accordance with the present invention, a method and system are provided for reducing plasma loss from the main chamber of a magnetic mirror fusion reactor (MMFR). The MMFR includes a mirror magnet defining a throat region and main chamber magnets defining a main chamber region adjacent the throat region. One of the main chamber magnets is adjacent the mirror magnet. The present invention generates a field reversed configuration (FRC) inside the MMFR and only between the mirror magnet and the main chamber magnet that is adjacent to the mirror magnet. One way to generate the FRC is to provide an antenna having conductors positioned in a region between the mirror magnet and the main chamber magnet that is adjacent to the mirror magnet. A source of sinusoidal current coupled to the antenna drives same to generate rotating magnetic fields about the MMFR at a frequency of rotation that is between the MMFR's plasma electron gyro frequency and plasma ion gyro frequency.

### BRIEF DESCRIPTION OF THE DRAWING(S)

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a perspective sectional view of one end of a conventional magnetic mirror fusion reactor illustrating the magnetic field lines therein;

FIG. 2 is a perspective sectional view of one end of a magnetic mirror fusion reactor modified in accordance with the present invention to reduce plasma loss through the throat region of the reactor; and

FIG. 3 is a schematic side sectional view of one end of an embodiment for generating a field reversed configuration for use in the present invention.

### DESCRIPTION OF THE PREFERRED EMBODIMENT(S)

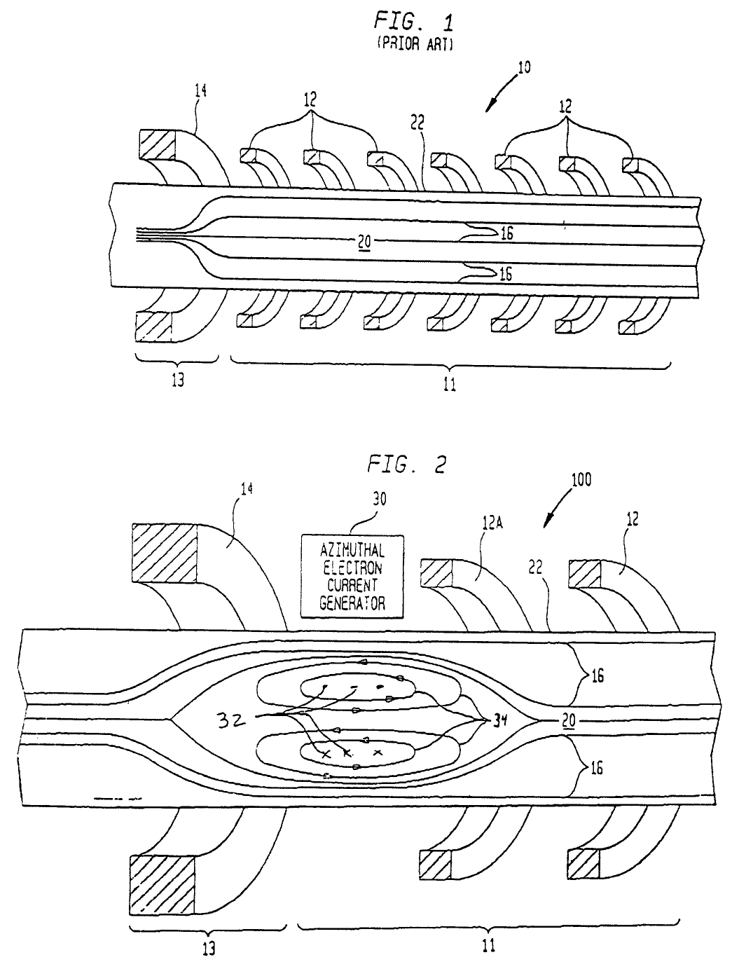

Referring again to the drawings, and more particularly to FIG. 2, a magnetic mirror fusion reactor (MMFR) modified in accordance with the present invention is illustrated and referenced generally by numeral 100. Common reference numerals are used for the elements that are the same as those described above with respect to the conventional MMFR 10 (FIG. 1). For purpose of description, only one end of MMFR 100 is illustrated. As would be understood by one of ordinary skill in the art, the other end of MMFR 100 (not shown) is a mirror image of the illustrated end.

In the present invention, an azimuthal electron current generator 30 is disposed in the region between mirror magnet 14 and the nearest or adjacent main chamber magnet 12A of main chamber magnets 12. When activated, azimuthal electron current generator 30 causes a field reversed configuration to develop inside MMFR 100 and only between mirror magnet 14 and adjacent main chamber magnet 12A. Specifically, a plasma electron current flow 32 (i.e., represented by the referenced “dots” and “x's” in the figures) is induced by generator 30 only at the ends of MMFR 100, e.g., between mirror magnet 14 and main chamber magnet 12A. Electron current flow 32 flows in circles through, and perpendicularly to, magnetic field 16. As a result of electron current flow 32, a field reversed configuration (FRC) 34 of magnetic field 16 is restricted to the region within MMFR 100 between mirror magnet 14 and main chamber magnet 12A. Field reversed configuration 34 essentially reverses the direction of magnetic field 16 produced by magnets 12 and 14. Field reversed configuration 34 resulting from electron current flow 32 forms a magnetic plug at the end of main chamber region 11 adjacent throat region 13. Since fusing plasma 20 is prevented from reaching throat region 13 due to the closed magnetic surfaces of field reversed configuration 34, the strength of mirror magnet 14 need only be sufficient to prevent the ejection of field reversed configuration 34 through throat region 13. Furthermore, since field reversed configuration 34 is restricted to a small region of MMFR 100, its stability is easily assured.

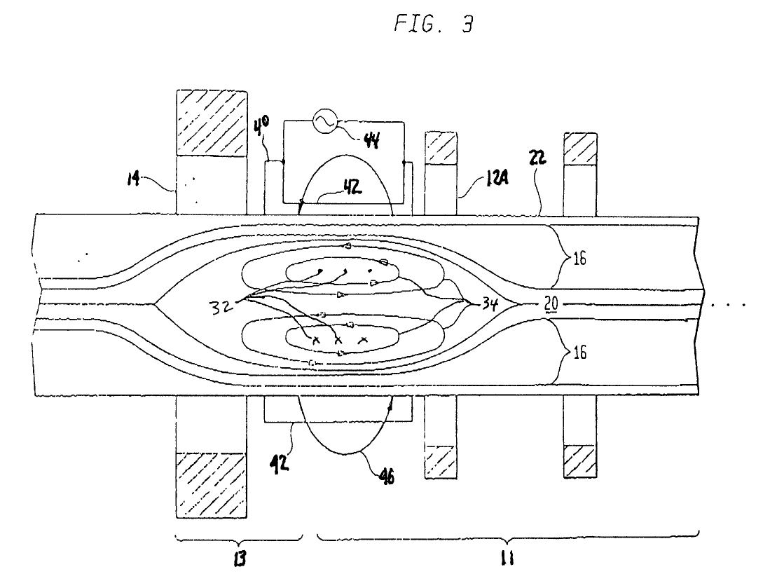

While electron current flow 32 and the resulting field reversed configuration 34 can be developed in the end of main chamber region 11 adjacent throat region 13 in a variety of ways, one way will be described herein by way of example. Referring now to FIG. 3, common reference numerals will again be used for the elements that are the same as those described above. Azimuthal electron current generator 30 (FIG. 2) is realized in FIG. 3 by an antenna 40 and a current source 44. Specifically, antenna 40 is disposed between mirror magnet 14 and adjacent main chamber magnet 12A. Antenna 40 is defined by conductors 42 which are coupled to and driven by current source 44. In terms of the present invention, a sinusoidal current from current source 44 is supplied to conductors 42 so that a rotating magnetic field 46 is generated between mirror magnet 14 and adjacent main chamber magnet 12A. Rotating magnetic field 46 induces electron current flow 32. As disclosed by A. J. Knight et al. in “A Quantitative Investigation of Rotating Magnetic Field Current Drive in a Field Reversed Configuration,” Plasma Physics and Controlled Fusion 32, 575 (1990), a field reversed configuration is generated when the frequency of rotation of rotating magnetic field 46 is between the plasma electron gyro frequency and the plasma ion gyro frequency of MMFR 100. That is, when this condition is achieved, electrons in fusing plasma 20 are magnetized and flow azimuthally as illustrated by electron current flow 32, while the ions in fusing plasma 20 remain stationary. To sustain electron current flow 32 and thereby provide a stable field reversed configuration 34 in the end of main chamber region 11, current source 44 is preferably one that can provide a steady-state sinusoidal current.

The advantages of the present invention are numerous. A magnetic plug can be formed in an MMFR by simply adding an antenna and current source to existing MMFR designs/configurations. By generating a field reversed configuration “plug” only at the end of the MMFR's main chamber adjacent the MMFR's throat region, the MMFR's mirror magnet can be sized to operate in a safe and economical fashion. The present invention makes MMFRs feasible for production of electrical power or as the basis for a fusion rocket engine.

Although the invention has been described relative to a specific embodiment thereof, there are numerous variations and modifications that will be readily apparent to those skilled in the art in light of the above teachings. For example, other methods/systems can be used to induce rotating magnetic field 46 at the preferred frequency of rotation. It is therefore to be understood that, within the scope of the appended claims, the invention may be practiced other than as specifically described.

What is claimed as new and desired to be secured by Letters Patent of the United States is:

1. In a magnetic mirror fusion reactor (MMFR) that includes a mirror magnet defining a throat region and main chamber magnets defining a main chamber region adjacent said throat region, wherein one of said main chamber magnets is adjacent said mirror magnet, a system for reducing plasma loss from the main chamber region comprising means for generating a field reversed configuration inside the MMFR and only between said mirror magnet and said one of said main chamber magnets.

2. A system as in claim 1 wherein said means for generating comprises:
an antenna positioned outside the MMFR between said mirror magnet and said one of said main chamber magnets; and
a source of sinusoidal current coupled to said antenna.

3. A system as in claim 2 wherein said source is a steady-state sinusoidal current source.

4. A system as in claim 1 wherein said means for generating provides rotating magnetic fields about the MMFR between said mirror magnet and said one of said main chamber magnets at a frequency of rotation.

5. A system as in claim 4 wherein said frequency of rotation is between the MMFR's plasma electron gyro frequency and plasma ion gyro frequency.

6. In a magnetic mirror fusion reactor (MMFR) that includes main chamber magnets disposed about a main chamber of the MMFR and a mirror magnet adjacent the main chambers a system for reducing plasma loss from the main chamber comprising:
an antenna having conductors positioned in a region between the mirror magnet and the main chamber magnets; and
a source of sinusoidal current coupled to said antenna for driving said antenna to generate rotating magnetic fields about the MMFR at said region at a frequency of rotation that is between the MMFR's plasma electron gyro frequency and plasma ion gyro frequency.

7. A system as in claim 6 wherein said source is a steady-state sinusoidal current source.

8. In a magnetic mirror fusion reactor (MMFR) that includes main chamber magnets disposed about a main chamber of the MMFR and a mirror magnet disposed adjacent the main chamber, a method of reducing plasma loss from the main chamber comprising the steps of:
providing an antenna outside the MMFR, said antenna having conductors positioned in a region between the mirror magnet and the main chamber magnets; and
driving said antenna with a steady-state sinusoidal current to generate rotating magnetic fields about the MMFR at said region at a frequency of rotation that is between the MMFR's plasma electron gyro frequency and plasma ion gyro frequency.
